(19) United States
(12) Patent Application Publication
(10) Pub. No.: US 2014/0136511 A1
(43) Pub. Date: May 15, 2014

(54) DISCOVERY AND USE OF NAVIGATIONAL RELATIONSHIPS IN TABULAR DATA

(71) Applicant: MICROSOFT CORPORATION, Redmond, WA (US)

(72) Inventors: Gregory Lawrence Hughes, Redmond, WA (US); Clemens Alden Szyperski, Bellevue, WA (US); Michael James Coulson, Clyde Hill, WA (US)

(73) Assignee: MICROSOFT CORPORATION, Redmond, WA (US)

(21) Appl. No.: 13/677,348

(22) Filed: Nov. 15, 2012

(51) Int. Cl. G06F 17/30

(52) U.S. Cl. 707/714; 707/803; 707/765; 707/E17.017; 707/E17.044

(57) ABSTRACT

Detection and use of relationships in tabular data is enhanced. A foreign-key-based relationship between two tables in memory is automatically discovered by a module. A view over table data is computationally augmented by adding an expandable hierarchical column. The expandable hierarchical column includes second table data that is related to rows of a first table by the discovered foreign-key-based relationship. A naming scheme for the added column is described. Sometimes the augmentation places an AddJoinColumn operator in a query expression tree; sometimes the tree is rewritten by moving a query operator or replacing a specified pattern of operators by a flat Join operation between two tables. Column expansion may be followed by reshaping data into a flat table, by getting a homogeneous query, by performing a join, or other operations.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Data is often organized into tables which have rows and columns; such data is referred to as “tabular data.” Some of the many familiar examples include data displayed in a spreadsheet, data printed in reports and other documents, and data stored in relational databases. Within relational databases, and in some other collections of tabular data, relationships exist between tables by virtue of their respective data. For instance, if a table A and a table B each contain a column for a particular aspect X of their respective rows of data, then tables A and B have a relationship through their respective columns for aspect X even though each table also has information not found in the other table.

Relationships in tabular data are generally easier to understand than they are to discover. Although a relationship can often be understood once it is known, and may provide insight into the meaning of data, hidden relationships in data often go unnoticed. As a practical matter, relationships between tables are often difficult to discover due to the presence of too many tables and too many columns for a human to readily process. Research suggests that the capacity of most people's “working memory” is about seven chunks of information, but it is not unusual for a database to contain dozens of tables and hundreds of columns. Differences in the names used by people to label columns of tabular data may also obscure relationships. Moreover, tabular data is often stored in digital forms whose conversion to human-readable form for human analysis of possible relationships would require substantial processing time; because database processing is often already complex, that conversion time to permit human detection of relationships would detract from other calculations.

### SUMMARY

Some embodiments described herein are directed to the technical problem of detecting relationships in tabular data, and the related technical problem of making the relationships visible to human users in a way that facilitates use of the relationships. Some embodiments improve usability of tabular data by discovering, and presenting in particular ways for use, a foreign-key-based relationship between tables of data.

One embodiment receives in a computer-readable memory a first table containing first table data which is organized through first schema information into first table rows and first table columns. The embodiment also receives in the computer-readable memory a second table containing second table data which is organized through second schema information into second table rows and second table columns. The first table data and the second table data each including overlapping data, namely, data which is present in both tables. The first table data also contains first non-overlapping data which is not present in the second table, and the second table data also contains second non-overlapping data which is not present in the first table.

This embodiment computationally makes a table relationship discovery, namely, it discovers a foreign-key-based relationship between the two tables through computational processing of the tables and their schema information. This is achieved without relying on any human analysis of the tables in order to make the relationship discovery. This embodiment proactively computationally augments a view over data in the first table by adding an expandable hierarchical column to the first table. The expandable hierarchical column includes second table data that is related to rows of the first table by the discovered foreign-key-based relationship. The added column may be given a name that is based at least in part on the name of the second table, using a scheme described below.

In some situations, usability is enhanced in that the expandable hierarchical column is a schema-level navigation column which facilitates user-controlled direct navigation between the two tables when data of the tables is being viewed by a human user. In some situations, navigation between the tables is enhanced in that prior to the augmentation neither table included a schema-level navigation column. In some situations, the fact that the data spans two tables (rather than being entirely located in a single table) is not disclosed to human users in views of the data prior to the discovery.

In some situations, the relationship discovery occurs in response to a query that invokes both tables. In some situations, the augmentation involves placing an AddJoinColumn operator in a query expression tree which represents at least a portion of the query. Some embodiments rewrite a query expression tree that represents at least a portion of the query. Rewriting the query expression tree may include one or more of the following: moving a query operator through an AddJoinColumn operator to settle on another AddJoinColumn operator or an initial table value; moving an ExpandListColumn operator or an ExpandRecordColumn operator through at least one other operator to settle on a corresponding AddJoinColumn operator or another Expand (-ListColumn or -RecordColumn) operator; replacing an EEA-instance by a flat Join operation between two tables, where the EEA-instance includes an ExpandRecordColumn which has as an input an ExpandListColumn which has an input an AddJoinColumn which has as inputs the two tables.

In some situations, the expandable hierarchical column is subsequently expanded. Expansion may be followed by reshaping data from the table with the hierarchical column into a flat table which has new columns that contain data from the expanded hierarchical column. Alternately or in addition, the column expansion may be followed by getting a homogeneous query that is made over the expanded hierarchical column. Alternately or in addition, the column expansion may be followed by performing a join over the two tables after the tables have been received from heterogeneous sources. In some embodiments, the join can be executed as a single query against a remote source if both tables originate from the same source.

From an architectural perspective, one embodiment includes a logical processor and a memory in operable communication with the processor. A first table and a second table each reside in the memory and have respective data which is organized through respective schema information into respective rows and columns of each table. A relationship discovery module includes relationship discovery code which upon execution by the processor interacts with the tables by computationally and proactively making a table relationship discovery, namely, proactively discovering a foreign-key-based relationship between the two tables through computational processing of the tables and their schema information.

A view augmentation module may be present, with view augmentation code which proactively computationally augments a view over the data in at least one of the tables. View augmentation for a table is accomplished by adding an expandable hierarchical column to that table and displaying the column in the view. The expandable hierarchical column includes data of the other table, namely, data that is related to rows of the expandable hierarchical column's table by the discovered foreign-key-based relationship. The view augmentation code may include code for one or more Table operators such as AddJoinColumn, ExpandListColumn, ExpandRecordColumn, and/or ExpandTableColumn.

Code to expand the expandable hierarchical column, code to reshape data into a flat table which has new columns that contain data from the expanded hierarchical column, and/or code to rewrite query expression trees may also be present.

In some situations, a homogeneous query is made over the expanded hierarchical column. In some, a query is made after one of the tables came from a non-relational data source. In some, a query is made after one of the tables came from a network database. In some, a join of the tables is performed after the tables came from heterogeneous sources. And in some situations, a query is made after the tables came from different respective data sources and is made while no preexisting query engine other than an instance of the system operates or operated on both of those sources. These possibilities are not necessarily mutually exclusive. For instance, a network database and a local relational database may serve as heterogeneous sources of tables which are then joined.

More generally, the examples given above are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory which interact with one another under the control of software for viewing results of database queries, and other items in an operating environment which may be present on multiple network nodes, and also illustrating configured storage medium (as opposed to mere transmission medium) embodiments;

FIG. 2 is a block diagram illustrating aspects of an example architecture for discovering and using navigational relationships in tabular data; and

FIG. 3 is a flow chart illustrating steps of some process and configured storage medium embodiments.

### DETAILED DESCRIPTION

### Overview

Relationships between tabular data are often present. One table may be a copy or a subset of another table, but relationships are more often a result of foreign key values in a table. Once such relationships are seen by an analyst, they are generally understood, and navigating the data with them can help the analyst understand the implications of the data in the related tables.

However, discovering and navigating the relationships between tabular data is difficult or intractable for most users. Factors such as too many tables, too many columns, limited or no access to internal data such as schemas, and focusing on particular business problems rather than the technical structures of the database, can each reduce the ability or efforts of human analysts to discover relationships in tabular data, as well as the ability or efforts to navigate the data using such relationships.

Some embodiments described herein address these problems by automatically discovering such relationships via foreign key information or other means and then adding new hierarchical columns to a table to nest related rows from another table within them. This provides an intuitive way for users to discover and navigate the relationships between the tables.

Some other technical approaches to providing navigation properties require a static specification of the relationships and a compilation step before the data can be presented in a hierarchical form. Some embodiments described herein do this dynamically without any preconstructed specifications.

Some other technical approaches do not allow reshaping of the data when expanding a navigation property. Some embodiments described herein allow true expansion of navigation columns into a flat table, similar to the result of a flat join between the tables, thus eliminating the expanded navigation column while preserving its contents within the parent table.

Some other technical approaches do not allow a homogeneous query over expanded navigation properties. Since there is no way to reshape the data in some of these approaches, an additional query syntax is used to operate against the content of the navigation properties; this additional syntax is both different from the usual syntax and limited in its abilities. Some embodiments described herein allow true expansion and flattening of navigation columns and as a result allow the same full set of query operators and the same query syntax to be used against the expanded navigation columns as one uses normally without such expansion.

Some embodiments described herein may be viewed in a broader context. For instance, concepts such as keys, operators, queries, schemas, tables, and trees may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and methods involving keys, operators, queries, schemas, tables, and/or trees are outside the present scope. Accordingly, vagueness, mere abstractness, lack of technical character, and accompanying proof problems are also avoided under a proper understanding of the present disclosure.

The technical character of embodiments described herein will be apparent to one of ordinary skill in the art, and will also be apparent in several ways to a wide range of attentive readers. First, some embodiments address technical problems such as how to achieve greater use of navigable relationships with existing query syntax and how to automatically discover relationships in tabular data. Second, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein add expandable hierarchical columns, expand such columns, add operator(s) to query expression trees, rewrite query expression trees while preserving query semantics, and/or reshape data into a flat table. Third, technical effects provided by some embodiments include augmented views of tabular data, results of queries from heterogeneous data sources, and reduced or removed avoidance on human analysis to identify foreign-key relationships. Fourth, some embodiments include technical adaptations such as nested tables and enhanced uses of existing query syntax. Fifth, technical advantages of some embodiments include improved usability of tabular data through increased availability of navigation columns, increased reliability in the injection of data from one table into a related table, and smaller interface real estate (e.g., screen space) in views of data tables which are related to each other. Sixth, some embodiments apply concrete technical means such as identification of foreign-key relationships and query expression tree rewrite operations to obtain particular technical effects such as expandable (or expanded) hierarchical columns directed to the specific technical problem(s) of identifying and using navigable relationships in tabular data, thereby providing a concrete and useful technical solution.

By way of further introduction, some embodiments described herein provide automatic, dynamic insertion of expandable hierarchical columns in views of relational data. Some reshape a data model from a table with a hierarchical column to a flat table when that column is expanded, thus preserving the user's technical ability to use and optimize the use of the same set of query operators against the data in the column as those used against regular tables. Some embodiments optimize an interleaved addition of hierarchical columns and other query operators (including subsequent expansion of those columns) to produce optimal queries against flat and/or relational data sources. Some generalize such mechanisms over heterogeneous data sources, thereby leveraging join-over-heterogeneous-sources technology. Some generalize such mechanisms to include the addition of other kinds of hierarchical columns, as well as their expansion, and optimizations thereof. Some embodiments provide a naming scheme for navigation properties to enhance discoverability and understandability of the relationship being represented. Some embodiments provide a mixture of the foregoing features, and some provide other features as well.

Reference will now be made to exemplary embodiments such as those illustrated in the drawings, and specific language will be used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, smartphones, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

As used herein, “include” allows additional elements (i.e., includes means comprises) unless otherwise stated. “Consists of means consists essentially of, or consists entirely of. X consists essentially of Y when the non-Y part of X, if any, can be freely altered, removed, and/or added without altering the functionality of claimed embodiments so far as a claim in question is concerned.

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. For example, certain familiar devices perform balance calculations to maintain their balance; some examples include mobile robots and SEGWAY® wheeled personal mobility devices (mark of Segway, Inc.). These devices are not part of the embodiments described herein but they illustrate the point that technical effects are provided by technical components, not by mere mental steps. Balance calculations simply cannot be performed rapidly enough by mental steps or by paper and pencil to provide the balance that is present in many mobile robots or wheeled personal mobility devices. The technical effect of having a dynamically balanced device is thus provided by technical components which include a processor and a memory interacting with balance control software. Similarly, the technical effect of a discovered and usable relationship is provided by technical components which include relationship discovery code and view augmentation code interacting with a processor and data in a computer-readable memory.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(5)”, “(es)”, or “(ies)” means that one or more of the indicated feature is present. For example, “processor(s)” means “one or more processors” or equivalently “at least one processor”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as adding, augmenting, avoiding, disclosing, discovering, expanding, getting, invoking, making, moving, naming, navigating, performing, placing, querying, receiving, replacing, reshaping, rewriting, viewing (and adds, added, augments, augmented, and so on) with regard to an item, destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. Unless expressly stated otherwise in a claim, a claim does not cover a signal per se. A memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as fleeting media or signal media, on the other hand. A transmission medium is a propagating signal or a carrier wave computer readable medium. By contrast, computer readable storage media and computer readable memory are not propagating signal or carrier wave computer readable media. Unless expressly stated otherwise, “computer readable medium” means a computer readable storage medium, not a propagating signal per se.

### Operating Environments

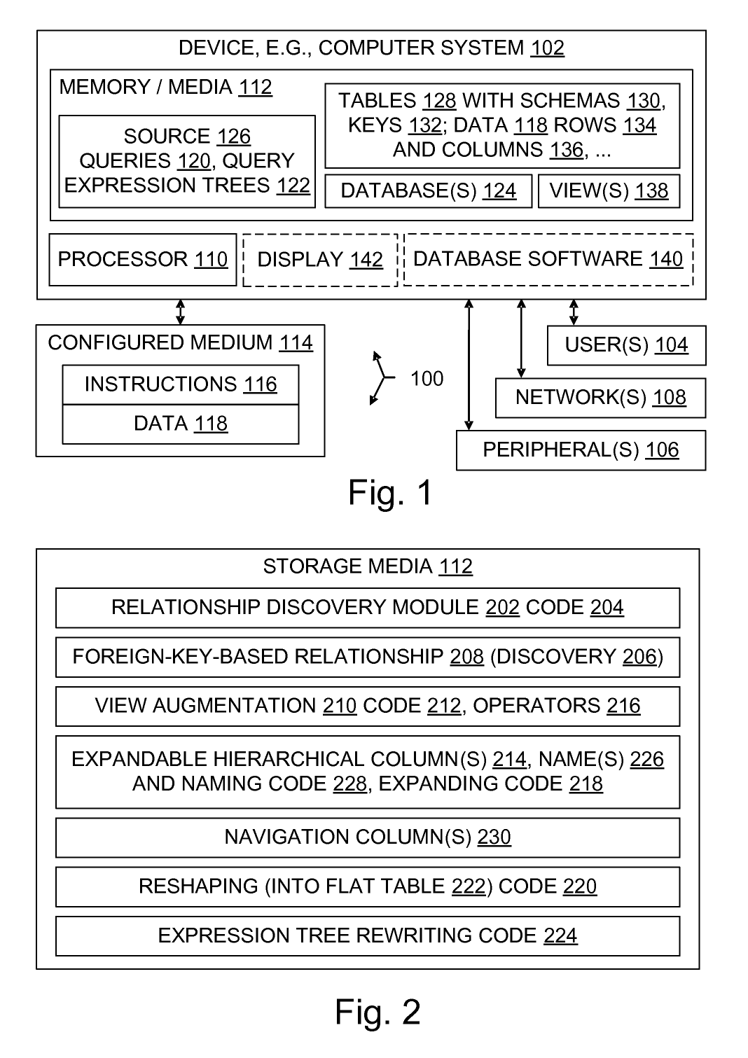

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A user interface may support interaction between an embodiment and one or more human users. A user interface may include a command line interface, a graphical user interface (GUI), natural user interface (NUI), voice command interface, and/or other interface presentations. A user interface may be generated on a local desktop computer, or on a smart phone, for example, or it may be generated from a web server and sent to a client. The user interface may be generated as part of a service and it may be integrated with other services, such as social networking services. A given operating environment includes devices and infrastructure which support these different user interface generation options and uses.

Natural user interface (NUI) operation may use speech recognition, touch and stylus recognition, gesture recognition both on screen and adjacent to the screen, air gestures, head and eye tracking, voice and speech, vision, touch, gestures, and/or machine intelligence, for example. Some examples of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (electroencephalograph and related tools).

One of skill will appreciate that the foregoing aspects and other aspects presented herein under “Operating Environments” may also form part of a given embodiment. This document's headings are not intended to provide a strict classification of features into embodiment and non-embodiment feature classes.

System administrators, database administrators, data analysts, developers, engineers, and end-users are each a particular type of user 104. Automated agents, scripts, playback software, and the like acting on behalf of one or more people may also be users 104. Storage devices and/or networking devices may be considered peripheral equipment in some embodiments. Other computer systems not shown in FIG. 1 may interact in technological ways with the computer system 102 or with another system embodiment using one or more connections to a network 108 via network interface equipment, for example.

The computer system 102 includes at least one logical processor 110. The computer system 102, like other suitable systems, also includes one or more computer-readable storage media 112. Media 112 may be of different physical types. The media 112 may be volatile memory, non-volatile memory, fixed in place media, removable media, magnetic media, optical media, and/or of other types of physical durable storage media (as opposed to merely a propagated signal). In particular, a configured medium 114 such as a CD, DVD, memory stick, or other removable non-volatile memory medium may become functionally a technological part of the computer system when inserted or otherwise installed, making its content accessible for interaction with and use by processor 110. The removable configured medium 114 is an example of a computer-readable storage medium 112. Some other examples of computer-readable storage media 112 include built-in RAM, ROM, hard disks, and other memory storage devices which are not readily removable by users 104. Neither a computer-readable medium nor a computer-readable memory includes a signal per se.

The medium 114 is configured with instructions 116 that are executable by a processor 110; “executable” is used in a broad sense herein to include machine code, interpretable code, bytecode, and/or code that runs on a virtual machine, for example. The medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations. Data 118 may be present in software code, in databases, and/or elsewhere in an environment 100.

Although an embodiment may be described as being implemented as software instructions executed by one or more processors in a computing device (e.g., general purpose computer, cell phone, or gaming console), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may grouped into interacting functional modules based on their inputs, outputs, and/or their technical effects, for example.

In the illustrated environments 100, one or more queries 120 (represented by query expression trees 122) are directed at data located in one or more databases 124 or other data sources 126. At least a portion of the data in the data sources 126 is organized in tables 128 according to schemas 130 that define keys 132, rows 134, and columns 136. Views 138 of data 118 are obtained for users 104 by using database software 140 such as query engines, and shown to users 104 on printouts and/or on displays 142 such as screens, monitors, and the like. The tables 128, views 138, and other items shown in the Figures and/or discussed in the text may each reside partially or entirely within one or more hardware media 112, thereby configuring those media for technical effects which go beyond the “normal” (i.e., least common denominator) interactions inherent in all hardware-software cooperative operation.

In addition to processors 110 (CPUs, ALUs, FPUs, and/or GPUs), memory/storage media 112, display(s) 142, and battery(ies), an operating environment may also include other hardware, such as buses, power supplies, wired and wireless network interface cards, and accelerators, for instance, whose respective operations are described herein to the extent not already apparent to one of skill. CPUs are central processing units, ALUs are arithmetic and logic units, FPUs are floating point processing units, and GPUs are graphical processing units.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

### Systems

FIG. 2 illustrates aspects of an architecture which is suitable for use with some embodiments. One embodiment includes a logical processor 110 and a memory 112 in operable communication with the processor. A first table 128 and a second table 128 each reside in the memory and have respective data 118 which is organized through respective schema 130 information into respective rows 134 and columns 136 of each table. A relationship discovery module 202 includes relationship discovery code 204 which upon execution by the processor 110 interacts with the tables 128 by computationally and proactively making a table relationship discovery 206, namely, proactively discovering a foreign-key-based relationship 208 between the two tables through computational processing of the tables and their schema information. “Modules” discussed herein include cooperative hardware and software code.

Some embodiments include a view augmentation module 210 with view augmentation code 212 which proactively computationally augments a view 138 over the data in at least one of the tables. View augmentation for a table 128 is accomplished by adding an expandable hierarchical column 214 to that table and displaying the column 214, 136 in the view 138. The expandable hierarchical column 214 includes data 118 of the other table 128, namely, data that is related to rows 134 of the expandable hierarchical column's table by the discovered foreign-key-based relationship 208. The view augmentation code 212 may include code for one or more operators 216 such as AddJoinColumn, ExpandListColumn, ExpandRecordColumn, and/or ExpandTableColumn. The expandable hierarchical column is given a name 226 in the view 138, provided by column 214 naming code 228. The expandable hierarchical column may serve as a navigation column 230.

Code 218 to expand the expandable hierarchical column, code 220 to reshape data into a flat table 222, 128 which has new columns that contain data from the expanded hierarchical column 214, and/or code 224 to rewrite query expression trees 122 may also be present in a given embodiment.

With continued reference to FIGS. 1 and 2, some embodiments provide a computer system 102 with a logical processor 110 and a memory medium 112 configured by circuitry, firmware, and/or software to provide technical effects such as augmented views 138 directed at technical problems such as exposing navigable relationships in tabular data, by extending functionality with one or more of modules 202, 210 and/or one or more of code 204, 212, 218, 220, 224, 228, as described herein.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a technical system, such that no human user 104 interacts directly with the embodiment. Software processes may be users 104, particularly in testing environments.

In some embodiments, the system includes multiple computers connected by a network. In particular, some embodiments can remotely execute a join/expansion query on a SQL server. Networking interface equipment can provide access to networks 108, using components such as a packet-switched network interface card, a wireless transceiver, or a telephone network interface, for example, will be present in a computer system. However, an embodiment may also communicate technical data and/or technical instructions through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, databases 124, tables 128, and other data sources 126 may be on multiple devices/systems 102 in a networked cloud, queries 120 directed at the data sources 126 may be initially generated on yet other devices within the cloud, and the augmented views 138 may configure the display on yet other cloud device(s)/system(s) 102.

### Processes

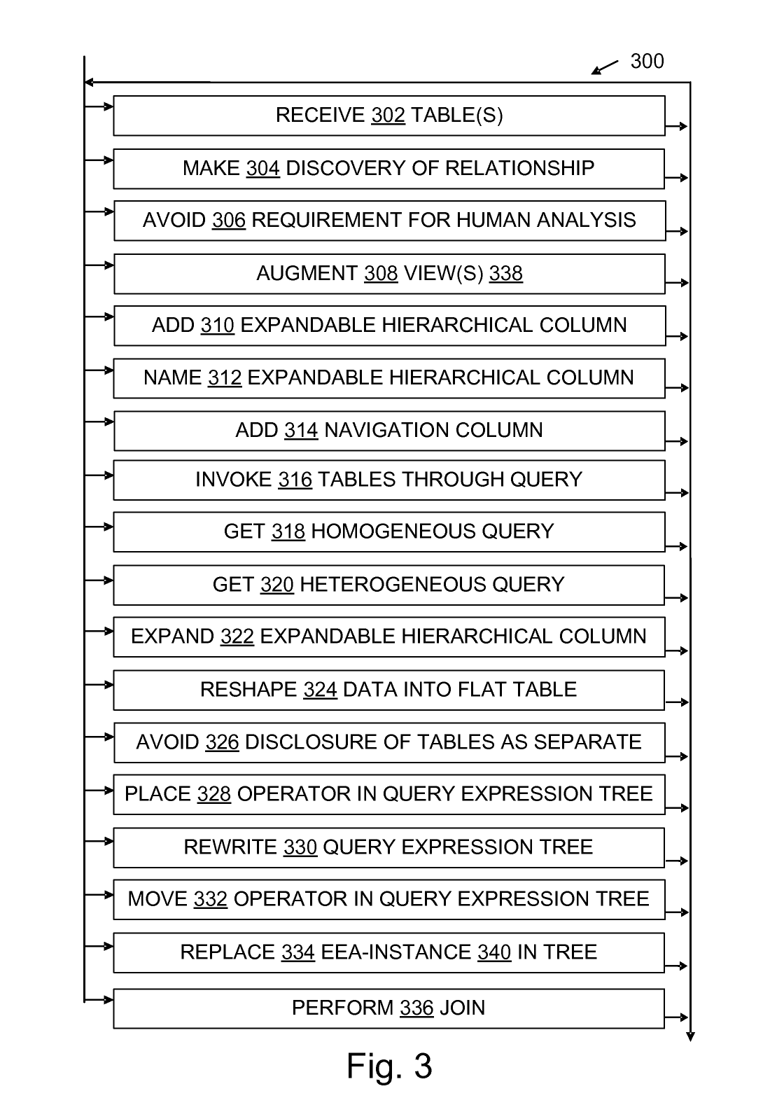

FIG. 3 illustrates some process embodiments in a flowchart 300. Technical processes shown in the Figures or otherwise disclosed may be performed in some embodiments automatically, e.g., by database software 140 under control of a script or otherwise requiring little or no contemporaneous live user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different technical features, mechanisms, and/or data structures, for instance, and may otherwise depart from the examples provided herein.

One embodiment receives 302 in a computer-readable memory 112 a first table 128 containing first table data which is organized through first schema information 130 into first table rows and first table columns. The embodiment also receives 302 in the computer-readable memory a second table containing second table data 118 which is organized through second schema 130 information into second table rows and second table columns. The memory 112 may be RAM, disk, or a combination of these or other memory storage devices, for example, and may be local, cluster storage, network attached storage, or other remote storage memory, for example. Receiving 302 a table does not necessarily involve retrieving the table (in the usual database retrieval operation sense). Indeed, some embodiments avoid retrieval when possible, performing query analysis and optimization (e.g., expression tree rewrites) before retrieving table data, thereby providing more efficient data retrieval. For instance, some embodiments perform key-based filtering between heterogeneous data sources, or via flat joins if both tables come from the same data source. Some embodiments asymptotically pull in table data only as the data is needed, e.g., by pulling only a set of related rows from the second table (via filters) that are needed to create a given expandable hierarchical column 214. The first table data and the second table data each including overlapping data 118, namely, data which is present in both tables. The first table data 118 also contains first non-overlapping data 118 which is not present in the second table, and the second table data 118 also contains second non-overlapping data 118 which is not present in the first table.

This embodiment computationally makes 304 a table relationship discovery, namely, it discovers a foreign-key-based relationship 208 between the two tables through computational processing of the tables and their schema information. This is achieved without relying on (avoiding 306 reliance on) any human analysis of the tables in order to make the relationship discovery 206.

This embodiment proactively computationally augments 308 a view 138 over data in the first table by adding 310 an expandable hierarchical column 214 to the first table, thus generating an augmented view 338, 138. The expandable hierarchical column 214 includes second table data that is related to rows of the first table by the discovered foreign-key-based relationship 208. The added column 214 may be named 312 with a name 226 that is based at least in part on the name of the second table, using a naming mechanism described herein.

In some situations utilizing a process or system described herein, usability is technologically enhanced in that the expandable hierarchical column 214 is a schema-level navigation column 230. Adding 314 a navigation column 230 facilitates user-controlled direct navigation between the two tables when data of the tables is being viewed by a human user 104. In some situations, navigation between the tables is enhanced in that prior to the augmentation 308 neither table 128 included a schema-level navigation column 230.

In some situations utilizing a process or system described herein, the relationship discovery occurs in response to a query 120 that invokes 316 both tables. The fact that the data 118 spans two tables 128 rather than being entirely located in a single table is not necessarily disclosed (thus, disclosure is avoided 326) to human users in views 138 of the data 118 prior to the time the relationship discovery was made 304, so a user will not necessarily realize that two (or more) tables were invoked by a given query.

In some situations utilizing a process or system described herein, the augmentation 308 involves placing 328 an AddJoinColumn operator 216 in a query expression tree 122 which represents at least a portion of the query 120. Some embodiments rewrite 330 a query expression tree 122 that represents at least a portion of a query 120. Rewriting 330 the query expression tree may include one or more of the following: moving 332 a query operator 216 through an AddJoinColumn operator 216 to settle on another AddJoinColumn operator 216 or an initial table 128 value; moving 332 an ExpandListColumn operator 216 or an ExpandRecordColumn operator 216 through at least one other operator 216 to settle on a corresponding AddJoinColumn operator 216 or another ExpandListColumn or ExpandRecordColumn operator 216; replacing 334 an EEA-instance 340 by a flat Join operation 216 between two tables 128. An EEA-instance 340 includes an ExpandRecordColumn operator 216 which has as an input an ExpandListColumn operator 216 which has an input an AddJoinColumn operator 216 which has as inputs two tables 128.

In some situations utilizing a process or system described herein, an expandable hierarchical column 214 is expanded 322. Expansion may be followed by reshaping 324 data 118 from the table having the hierarchical column 214 into a flat table 222 which has new columns 136 that contain data from the expanded hierarchical column. Alternately or in addition, the column expansion 322 may be followed by getting 318 a homogeneous query or getting 320 a heterogeneous query, either query being made over the expanded hierarchical column. Alternately or in addition, the column expansion 322 may be followed by performing 336 a join over the two tables after the tables have been received from homogeneous or heterogeneous sources 126.

In some situations utilizing a process or system described herein, a homogeneous query 120 is made over the expanded hierarchical column 214. In some, a query 120 is made after one of the tables 128 came from a non-relational data source 126. In some, a query 120 is made after one of the tables 128 came from a network database 124. In some, a join of the tables is performed 336 after the tables came from heterogeneous sources. And in some situations, a query 120 is made after the tables came from different respective data sources 126 and is made while no preexisting query engine other than an instance of the system operates or operated on both of those sources.

The various possibilities noted above are not necessarily mutually exclusive. For instance, a network database and a local relational database may serve as heterogeneous sources of tables which are then joined; and multiple expandable hierarchical columns 214 may be added 310 to a given table without necessarily then expanding 322 every one of those added columns. The steps and components described herein may also be combined in many other ways, which will be apparent to one of skill in the art.

### Configured Media

Some embodiments include a configured computer-readable storage medium 112. Medium 112 may include disks (magnetic, optical, or otherwise), RAM, EEPROMS or other ROMs, and/or other configurable memory, including in particular computer-readable media (as opposed to mere propagated signals). The storage medium which is configured may be in particular a removable storage medium 114 such as a CD, DVD, or flash memory. A general-purpose memory, which may be removable or not, and may be volatile or not, can be configured into an embodiment using items such as one or more of modules 202, 210, code 204, 212, 218, 220, 224, 228, rewritten tree 122, or augmented view 338, in the form of data 118 and instructions 116, read from a removable medium 114 and/or another source such as a network connection, to form a configured medium. The configured medium 112 is capable of causing a computer system to perform technical process steps for relationship discovery and view augmentation as disclosed herein. FIGS. 1 through 3 thus help illustrate configured storage media embodiments and process embodiments, as well as system and process embodiments. In particular, any of the process steps illustrated in FIG. 3 or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that some implementation details may pertain to specific code, such as specific APIs, specific language syntax, and/or specific sample programs, and thus need not appear in every embodiment. In particular, although some examples use M language syntax and/or include examples tables as named inline tables, it will be recognized that other syntaxes and/or table naming conventions can be used in other embodiments consistent with teachings provided herein, e.g., consistent with process steps illustrated in FIG. 3 and/or systems illustrated in FIGS. 1 and 2. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

A portion of the discussion herein is derived from Data Explorer documentation. Data Explorer is a program implemented by Microsoft Corporation. Aspects of the Data Explorer program and/or documentation are consistent with or otherwise illustrate aspects of the embodiments described herein. However, it will be understood that Data Explorer documentation and/or implementation choices do not necessarily constrain the scope of such embodiments, and likewise that Data Explorer and/or its documentation may well contain features that lie outside the scope of such embodiments. It will also be understood that the discussion herein is provided in part as an aid to readers who are not necessarily of ordinary skill in the art, and thus may contain and/or omit details whose recitation is not strictly required to support the present disclosure.

Some embodiments assumes the existence of a query expression tree 122 data structure that is used to describe query plans, a robust set of query operators 216 for use in the expression tree, and an execution engine in database software 140 to evaluate expression trees. In this context, some new query operators 216 are added. An added AddJoinColumn operator 216 describes the addition of a hierarchical column 214 to a table 128. The hierarchical column 214 contains a nested table of the rows related to each row of the first table from a second table. An added ExpandListColumn operator 216 vertically expands a hierarchical column 214, for each row from the first table creating rows that are the cross-product of the row from the first table and the rows from the nested table within the column. The data 118 from each row in the nested table is represented as a record nested within a column in the new row. An added ExpandRecordColumn operator 216 horizontally expands a column 214 containing a nested record by creating a column for each field of the nested record.

In some embodiments, a query node located within a tree 122 and representing a table is provided. Information about its foreign-key relationships 208 with other tables is gathered and analyzed.

In some embodiments, names 226 for the navigation columns 214 to be created from the relationship information are synthesized by naming code 228 as follows. The name of the second (target) table is used as the name 226 except as follows. If multiple relationships from the first (source) table to the second (target) table exist, the names of the key columns from the first (source) table are appended to the name of the second (target) table. If the proposed name 226 conflicts with previous columns 136, a number is appended to the table (e.g. 2, 3, 4) to indicate that this is the Nth representation of a similar relationship with the second (target) table.

In some embodiments, for each foreign-key relationship 208 an AddJoinColumn node (e.g., operator 216 node in a tree 122) is placed 328 (e.g., added) around the query node (or previous AddJoinColumn nodes) that describes the construction of a new hierarchical column 214 that will contain a nested table of the rows from the second table related to each row of the first table as indicated in the relationship. For each foreign-key relationship 208 that is 1:1 or N:1 (one-to-one or N-to-one), an ExpandListColumn operator 216 is wrapped around the AddJoinColumn operator 216. This allows 1:1 and N:1 navigation columns to be represented as singleton records instead of nested tables (with one row), for better usability and discoverability.

In some embodiments, as the expression tree 122 is further built up by adding more query operators (e.g. as a user interacts with a product to build queries), rewrites 330 of the expression tree occur as follows. When possible without altering query semantics, query operators are moved 332 down through AddJoinColumn operators to settle directly on top of the initial table value or other AddJoinColumn operators. When possible without altering query semantics, ExpandListColumn and ExpandRecordColumn operators are moved 332 down through all other operators to settle on top of their corresponding AddJoinColumn operators or corresponding expand operators.

In some embodiments, rewrites 330 also involve EEA-instances 340. When a pattern of ExpandRecordColumn(ExpandListColumn(AddJoinColumn)) is detected for a column, the pattern is replaced 334 by a flat Join operation between the tables that are inputs to the AddJoinColumn operation. This step helps an embodiment obtain good performance for a join operation. Without this rewrite, numerous queries (one per row from the first (source) table) would be generated to retrieve the subset of related data from the second (target) table for each row. With this rewrite, it is possible to send a single join query to the source to do the same thing.

With regard to all rewrites 330, in some embodiments the operators affected by these rewrites are reconfigured as needed to preserve the semantics of the query tree. This reconfiguration may also include the introduction of new operations into the tree to compensate for this reconfiguration and to preserve the semantics and shape of the result. Note that further AddJoinColumn and expansion operations 216 may also be added at any time, e.g. by the user 104 relating tables from disparate sources 126 for which no relationship information was available. Rewriting will continue to work as described, e.g. expand operations end up next to corresponding AddJoinColumn operations and are translated into flat Joins.

In some embodiments, when construction (e.g., operator placement 328, movement 332, replacement 334) of the query expression tree 122 is complete the tree is executed. Flat joins (expanded navigation columns) are either evaluated on a single source via query folding technology or evaluated locally in the engine software 140 via adaptive join algorithms. In some, a drill-down into a navigation column 230 from a single row results in a filtering query 120 to retrieve only the data 118 from the second (target) table related to that row from the first (source) table. This query 120 is either sent to the source (e.g., by query folding technology) or evaluated locally.

Some embodiments provide a method to facilitate discovery and use of relationships in tabular data. One embodiment includes the steps of receiving 302 a first table containing some tabular data, receiving 302 a second table containing some tabular data that is not present in the first table, proactively discovering 304 a foreign-key-based relationship between the two tables, and proactively adding 310 an expandable hierarchical column to a view which includes at least some of each table's tabular data that is related by the discovered relationship. As noted, receiving does not require retrieving; some embodiments only retrieve table schema 130 information from a table whose data is received (i.e., stored somewhere accessible) but not retrieved by step 302. Accordingly, one could delay transmission of table data until after the reduction to a join operation, thus transmitting only the data that resulted from the join versus transmitting the inputs. In some embodiments, there is at least some overlap in the data of the tables to permit the join to occur by equality or as an equijoin (the foreign-key join); other kinds of joins can also be supported, e.g. theta joins which support equality and inequality conditions. In the foreign key join case one column from each table will contain the same values and this is usually (but not always) the primary key column on one side and the foreign key column on the other side. Some embodiments involve augmenting a view over the data in the first table by adding an expandable hierarchical column that includes data from the second table that is related to each row of the first table by the discovered relationship. Adding new columns to the first table permits a new view 338 over that data to be created.

In at least some cases, the expandable hierarchical column added by the method discussed above is a navigation column 230. For example, a navigation column may be a column in a table A, each cell of which contains a nested table that is comprised of the rows from another table B that are related to the row in table A by a relationship, usually of the form of but not limited to that of a foreign-key relationship in a relational database. Navigation columns are sometimes referred to as navigation properties; at the schema 130 level, these two are the same. At the instance level, navigation properties allude to a navigable property on a single given entity/instance, while navigation columns represent a collectively navigable column in a table of rows/instances. So one may also take a stricter view in which navigation columns are a concept at the set or table level, while navigation properties are a concept at element or entity level. This is a subtle line to draw, however, and embodiments described herein include either or both understandings of the terms “navigation column” and “navigation property” (namely, the understanding that they are equivalent or the understanding that they are distinct).

In some cases, neither of the tables received 302 have any navigation columns prior to the addition 310 of an expandable hierarchical column. This is only in some cases; an embodiment may continually add 310, 314 new columns for other related tables to the view over the first table, and after the initial column 214 is added there is always at least one navigation column present.

In some embodiments, methods described above occur in response to a query that invokes both tables. However, the fact that multiple tables are involved may be hidden from the user. For example, when accessing a relational database (e.g. a SQL server database) all of the tables are known up front in a shared context and navigation columns are generated from this knowledge.

In at least some cases, an embodiment places 328 an AddJoinColumn operator in a query expression tree. The embodiment can then be supplemented to optimize interleaved addition of hierarchical columns and other query operators, including subsequent expansion of those columns, to produce optimal queries against flat/relational data sources. This optimization can be done by rewriting the tree according to the rules implicated by moving 332 and/or replacing 334 operators as discussed above. The optimization/interleaving rewrites 330 can also be applied to data sources with native navigation properties like an Open Data Protocol feed.

In some cases, after an embodiment adds the expandable hierarchical column, the column is later expanded 322. In some of these cases, data model reshaping occurs, namely, data is reshaped from a table with a hierarchical column to a flat table with new columns that contain the data from the column when it is expanded. This helps preserve the ability to use (and optimize the use of) the same set of query operators against the data in the now-flattened hierarchical column as those query operators which are used against “regular” tables (regular tables are tables that do not have any expandable hierarchical columns); the operators can also be used against tables with hierarchical columns as long as they do not manipulate the data in the hierarchical columns.

After an embodiment adds the expandable hierarchical column, and the column is later expanded, in some cases a homogeneous query is made over the expanded hierarchical column. The query is “homogeneous” in that the data in both tables originates from the same data source. The query may also contain optimizations (tree rewrites 330) as discussed herein, e.g., introducing a flattened join. In such cases the retrieval of data from the original tables can be avoided by retrieving the data from the result of the join, thus providing better performance.

In some cases, the two tables each come from a different source and there is no preexisting query engine that operates on both sources. That is, there is no query engine other than the engine that is driving the embodiment. For example, one of the tables may come from a non-relational data source such as a network database. The query may also contain optimizations (tree rewrites 330) as discussed herein, e.g., introducing a flattened join. In some cases, familiar join-over-heterogeneous-sources technology is used after the embodiment utilizes 330 an efficient strategy to determine what data to retrieve as the data for the join; the heterogeneous join then retrieves data accordingly.

In some systems or methods (a.k.a. processes), the following operators are provided: AddJoinColumn, ExpandListColumn, ExpandRecordColumn, and ExpandTableColumn. Suitable semantics of these operators 216 are illustrated below.

AddJoinColumn

Given two tables (parent, child) this operator will create a new column in the parent table that contains the related entities from the child table for each row of the parent table. Thus,

```
let
  t1 = {[A=1],[A=2]} as table [A = Number.Type],
  t2 = {[B=1,C=1],[B=2,C=2],[B=3,C=3],[B=2,C=4]} as table [B =
Number.Type, C = Number.Type]
in
  AddJoinColumn(t1, “A”, ( ) => t2, “B”, “Bs”)
```

would yield (where the Bs column contains a list of the rows from t2 that relate to each row from t1):

| 1. A | 2. Bs |
|---|---|
| 3. 1 | 4. { |
| | [B=1,C=1] |
| | 5. } |
| 6. 2 | 7. { |
| | [B=2,C=2] |
| | [B=2,C=4] |
| | } |

ExpandListColumn

Given a table with a column that contains a list of items in each row, this operator vertically expands the table so that each of the items in the list gets its own copy of the row. Using example1 to denote the table from the AddJoinColumn example,

ExpandListColumn(example1,“Bs”)

would yield (note only 1 value in each row for the Bs column, A=2 was duplicated to make this so):

| 8. A | 9. Bs |
|---|---|
| 10. 1 | 11. [B=1,C=1] |
| 12. 2 | 13. [B=2,C=2] |
| 14. 2 | 15. [B=2,C=4] |

ExpandRecordColumn

Given a table with a column that contains a record in each row, this operator horizontally expands the table so that the values of the fields in the row exist as columns in the table. Using example2 to denote the table from the ExpandListColumn example,

ExpandRecordColumn(example2,“Bs”,{“B”,“C”})

would yield (note the elimination of the Bs column and promotion of the B and C fields of the record for each row):

| 16. A | 17. B | 18. C |
|---|---|---|
| 19. 1 | 20. 1 | 21. 1 |
| 22. 2 | 23. 2 | 24. 2 |
| 25. 2 | 26. 2 | 27. 4 |

ExpandTableColumn

This operator is the equivalent of ExpandRecordColumn and ExpandListColumn applied to a column together. Using example1 to denote the table from the AddJoinColumn example, ExpandListColumn(example1, “Bs”, {“B”, “C”}) would yield:

| 28. A | 29. B | 30. C |
|---|---|---|
| 31. 1 | 32. 1 | 33. 1 |
| 34. 2 | 35. 2 | 36. 2 |
| 37. 2 | 38. 2 | 39. 4 |

With regard to discovering and/or navigating data relationships, it will be understood that the relationships between tables in a tabular data store (e.g., a database) are typically stored out-of-band from the data itself and are not easily discovered by a user.

For example, the two tables (Customers and Orders) illustrated by excerpts below are related by CustomerID but it is not readily apparent from the data in the tables that this relationship exists explicitly. One might infer that the relationship exists by the similar names of the columns, but names can be deceptive, in that similar names do not necessarily mean the relationship is modeled in the database. The excerpts are based on a Microsoft® Northwind sample database, but the teachings herein also apply to other databases (mark of Microsoft Corporation).

Customers table excerpt:

| CustomerID | CompanyName | ContactName | ContactTitle | Address | City |
|---|---|---|---|---|---|
| ALFKI | Alfreds | Maria Anders | Sales | Obere Str. 57 | Berlin |
| | Futterkiste | | Representative | | |
| ANATR | Ana Trujillo | Ana Trujillo | Owner | Avda. de la | México |
| | Emparedados | | | Constitución | D.F. |
| | y helados | | | 2222 | |
| ANTON | Antonio | Antonio | Owner | Mataderos | México |
| | Moreno | Moreno | | 2312 | D.F. |
| | Taquería | | | | |
| AROUT | Around the | Thomas | Sales | 120 Hanover | London |
| | Horn | Hardy | Representative | Sq. | |
| BERGS | Berglunds | Christina | Order | Berguvsvägen 8 | Lulea |
| | snabbköp | Berglund | Administrator | | |
| BLAUS | Blauer See | Hanna Moos | Sales | Forsterstr. 57 | Mannheim |
| | Delikatessen | | Representative | | |

Orders table excerpt:

| OrderID | CustomerID | EmployeeID | OrderDate |
|---|---|---|---|
| 10248 | VINET | 5 | 1996-07-04 00:00:00.000 |
| 10249 | TOMSP | 6 | 1996-07-05 00:00:00.000 |
| 10250 | HANAR | 4 | 1996-07-08 00:00:00.000 |
| 10251 | VICTE | 3 | 1996-07-08 00:00:00.000 |
| 10252 | SUPRD | 4 | 1996-07-09 00:00:00.000 |
| 10253 | HANAR | 3 | 1996-07-10 00:00:00.000 |

In this example, the relationship information is stored in the database 124 but is represented there in a way not readily apparent from the two tables above, in that apprehending the relationship requires access to schema 130 tables such as those illustrated by the following excerpts:

| name | object_id | parent_object_id | type_desc |
|---|---|---|---|
| FK_Employees_Employees | 1013578649 | 37575172 | FOREIGN_KEY_CONSTRAINT |
| FK_Orders_Customers | 1029578706 | 149575571 | FOREIGN_KEY_CONSTRAINT |
| FK_Orders_Employees | 1045578763 | 149575571 | FOREIGN_KEY_CONSTRAINT |
| FK_Orders_Shippers | 1061578820 | 149575571 | FOREIGN_KEY_CONSTRAINT |
| FK_CustomerCustomerDemo | 1077578877 | 181575685 | FOREIGN_KEY_CONSTRAINT |

| constraint_object_id | parent_object_id | parent_column_id | referenced_object_id |
|---|---|---|---|
| 1125579048 | 213575799 | 3 | 5575058 |
| 1013578649 | 37575172 | 17 | 37575172 |
| 1045578763 | 149575571 | 3 | 37575172 |
| 1157579162 | 341576255 | 1 | 37575172 |
| 1109578991 | 213575799 | 4 | 69575286 |

Some embodiments described herein address this technical problem of obscurity and complexity by representing the relationships as nested tables within the data of the parent table, e.g., as hierarchical data indicated by “Table” links in the following excerpt (of course, a label other than “Table” can also be used):

| | | Customer- | | | |
|---|---|---|---|---|---|
| | | Customer- | | | |
| CustomerID | CompanyName | Demo | Orders | CompanyName | ContactName |
| ALFKI | Alfreds | Table | Table | Alfreds Futterkiste | Maria Anders |
| | Futterkiste | | | | |
| ANATR | Ana Trujillo | Table | Table | Ana Trujillo | Ana Trujillo |
| | Emparedados | | | Emparedados y | |
| | y helados | | | helados | |
| ANTON | Antonio | Table | Table | Antonio Moreno | Antonio Moreno |
| | Moreno | | | Taquería | |
| | Taquería | | | | |
| AROUT | Around the | Table | Table | Around the Horn | Thomas Hardy |
| | Horn | | | | |
| BERGS | Berglunds | Table | Table | Berglunds snabbköp | Christina Berglund |
| | snabbköp | | | | |
| BLAUS | Blauer See | Table | Table | Blauer See | Hanna Moos |
| | Delikatessen | | | Delikatessen | |

In this example, the “Table” links in the foregoing table lead to the data from the other table that is related to the row when accessed via hierarchical navigation:

| OrderID | CustomerID | EmployeeID | OrderDate | ShippedDate |
|---|---|---|---|---|
| 10643 | ALFKI | 6 | 8/25/1997 | 9/2/1997 |
| | | | 12:00 AM | 12:00 AM |
| 10692 | ALFKI | 4 | 10/3/1997 | 10/13/1997 |
| | | | 12:00 AM | 12:00 AM |
| 10702 | ALFKI | 4 | 10/13/1997 | 10/21/1997 |
| | | | 12:00 AM | 12:00 AM |
| 10835 | ALFKI | 1 | 1/15/1998 | 1/21/1998 |
| | | | 12:00 AM | 12:00 AM |
| 10952 | ALFKI | 1 | 3/16/1998 | 3/24/1998 |
| | | | 12:00 AM | 12:00 AM |
| 11011 | ALFKI | 3 | 4/9/1998 12:00 AM | 4/13/1998 |
| | | | | 12:00 AM |

As noted elsewhere herein, some other approaches rely on static specification of the relationships. For example, an Entity Data Model (e.g., via Common Schema Definition Language would be specified to create an Open Data Protocol representation over the data, such as in model source:

```
    <AssociationSet Name=“FK_Orders_Customers”
Association=“NorthwindModel.FK_Orders_Customers”>
      <End Role=“Customers” EntitySet=“Customers” />
      <End Role=“Orders” EntitySet=“Orders” />
    </AssociationSet>
    <Association Name=“FK_Orders_Customers”>
      <End Role=“Customers” Type=“NorthwindModel.Customer”
Multiplicity=“0..1” />
      <End Role=“Orders” Type=“NorthwindModel.Order”
      Multiplicity=“*” />
      <ReferentialConstraint>
      <Principal Role=“Customers”>
        <PropertyRef Name=“CustomerID” />
      </Principal>
      <Dependent Role=“Orders”>
        <PropertyRef Name=“CustomerID” />
      </Dependent>
      </ReferentialConstraint>
    </Association>
```

Some embodiments described herein do not require this extra level of specification and infer this relationship information dynamically from the database schema 130.

As also noted elsewhere herein, some other approaches do not allow reshaping of data. For example, Open Data Protocol supports an $expand operator that allows selection of related data (from a navigation property) but it maintains the hierarchical relationship and provides no way to flatten the data. This is illustrated by the following example showing a result of an http://services dot odata.org/Northwind/Northwind.svc/Customers?$expand=Orders command.

To conform with United States Patent and Trademark Office procedures, web addresses in the examples have been converted by changing periods to “dot” to make it clear that no live links or other incorporation by reference is intended—web addresses herein are for illustration only.

This example begins by referencing services for Microsoft's Northwind database, from which the example is adapted:

<?xml version=“1.0” encoding=“utf-8” standalone=“yes”?><feed
xml:base=“http://services dot odata dot org/Northwind/Northwind.svc/”
xmlns:d=“http://schemas dot microsoft dot com/ado/2007/08/dataservices”
xmlns:m=“http://schemas dot microsoft dot com/ado/2007/08/dataservices/
metadata” xmlns=“http://www dot w3 dot org/2005/Atom”>

The example then defines a Customer entity:

```
<content type=“application/xml”>
  <m:properties>
  <d:CustomerID>ALFKI</d:CustomerID>
  <d:CompanyName>Alfreds Futterkiste</d:CompanyName>
  <d:ContactName>Maria Anders</d:ContactName>
  <d:ContactTitle>Sales Representative</d:ContactTitle>
  <d:Address>Obere Str. 57</d:Address>
  <d:City>Berlin</d:City>
  <d:Region m:null=“true” />
  <d:PostalCode>12209</d:PostalCode>
  <d:Country>Germany</d:Country>
  <d:Phone>030-0074321</d:Phone>
  <d:Fax>030-0076545</d:Fax>
  </m:properties>
</content>
```

A nested order entity is also defined. Note that in this portion of the example some reformatting has been done to reduce the number of lines listed, without sacrificing substantive content:

```
  <link rel=“self” title=“Customers” href=“Customers” />
  <entry><id>http://services dot odata dot
org/Northwind/Northwind.svc/Customers(‘ALFKI’)</id>
    <title type=“text”></title>
    <updated>2012-10-12T20:34:48Z</updated>
    <author><name /></author>
    <link rel=“edit” title=“Customer” href=“Customers(‘ALFKI’)” />
    <link rel=“http://schemas dot microsoft dot com/ado/2007/08/
dataservices/related/Orders” type=“application/atom+xml;type=feed”
title=“Orders” href=“Customers(‘ALFKI’)/Orders”>
    <m:inline> <feed> <title type=“text”>Orders</title>
    <id>http://services dot odata dot
org/Northwind/Northwind.svc/Customers(‘ALFKI’)/Orders</id>
    <updated>2012-10-12T20:34:48Z</updated>
    <link rel=“self” title=“Orders” href=“Customers(‘ALFKI’)/
    Orders” />
    <entry><id>http://services dot odata dot
org/Northwind/Northwind.svc/Orders(10643)</id>
      <title type=“text”></title>
      <updated>2012-10-12T20:34:48Z</updated>
      <author><name /></author>
      <link rel=“edit” title=“Order” href=“Orders(10643)” />
      <link rel=“http://schemas dot microsoft dot com/ado/2007/08/
dataservices/related/Customer” type=“application/atom+xml;type=entry”
title=“Customer” href=“Orders(10643)/Customer” />
      <link rel=“http://schemas dot microsoft dot com/ado/2007/08/
dataservices/related/Employee” type=“application/atom+xml;type=entry”
title=“Employee” href=“Orders(10643)/Employee” />
      <link rel=“http://schemas dot microsoft dot com/ado/2007/08/
dataservices/related/Order_Details” type=“application/
atom+xml;type=feed” title=“Order_Details”
href=“Orders(10643)/Order_Details” />
      <link rel=“http://schemas dot microsoft dot
com/ado/2007/08/dataservices/related/Shipper”
type=“application/atom+xml;type=entry” title=“Shipper”
href=“Orders(10643)/Shipper” />
      <category term=“NorthwindModel.Order” scheme=“http://schemas
dot microsoft dot com/ado/2007/08/dataservices/scheme” />
      <content type=“application/xml”>
      <m:properties>
        <d:OrderID m:type=“Edm.Int32”>10643</d:OrderID>
        <d:CustomerID>ALFKI</d:CustomerID>
        <d:EmployeeID m:type=“Edm.Int32”>6</d:EmployeeID>
        <d:OrderDate m:type=“Edm.DateTime”>1997-08-
25T00:00:00</d:OrderDate>
        <d:RequiredDate m:type=“Edm.DateTime”>1997-09-
22T00:00:00</d:RequiredDate>
        <d:ShippedDate m:type=“Edm.DateTime”>1997-09-
02T00:00:00</d:ShippedDate>
        <d:ShipVia m:type=“Edm.Int32”>1</d:ShipVia>
        <d:Freight m:type=“Edm.Decimal”>29.4600</d:Freight>
        <d:ShipName>Alfreds Futterkiste</d:ShipName>
        <d:ShipAddress>Obere Str. 57</d:ShipAddress>
        <d:ShipCity>Berlin</d:ShipCity>
        <d:ShipRegion m:null=“true” />
        <d:ShipPostalCode>12209</d:ShipPostalCode>
        <d:ShipCountry>Germany</d:ShipCountry>
      </m:properties>
      </content>
    </entry>
```

In contrast, some embodiments allow the data to be flattened by an expand operation. Flattening is an example of reshaping 324. For example, data may be flattened from:

| CustomerID | CompanyName | Orders | ContactName | ContactTitle |
|---|---|---|---|---|
| ALFKI | Alfreds | Table | Maria Anders | Sales |
| | Futterkiste | | | Representative |
| ANATR | Ana Trujillo | Table | Ana Trujillo | Owner |
| | Emparedados | | | |
| | y helados | | | |
| ANTON | Antonio | Table | Antonio | Owner |
| | Moreno | | Moreno | |
| | Taquería | | | |
| AROUT | Around the | Table | Thomas | Sales |
| | Horn | | Hardy | Representative |
| BERGS | Berglunds | Table | Christina | Order |
| | snabbköp | | Berglund | Administrator |
| BLAUS | Blauer See | Table | Hanna Moos | Sales |
| | Delikatessen | | | Representative |

(via expansion of the Orders column, taking the OrderID and OrderDate columns from the nested tables):

| CustomerID | CompanyName | ContactName | ContactTitle | OrderID | OrderDate |
|---|---|---|---|---|---|
| ALFKI | Alfreds | Maria Anders | Sales | 10643 | 8/25/1997 |
| | Futterkiste | | Representative | | 12:00 AM |
| ALFKI | Alfreds | Maria Anders | Sales | 10692 | 10/3/1997 |
| | Futterkiste | | Representative | | 12:00 AM |
| ALFKI | Alfreds | Maria Anders | Sales | 10702 | 10/13/1997 |
| | Futterkiste | | Representative | | 12:00 AM |
| ALFKI | Alfreds | Maria Anders | Sales | 10835 | 1/15/1998 |
| | Futterkiste | | Representative | | 12:00 AM |
| ANATR | Ana Trujillo | Ana Trujillo | Owner | 10926 | 3/4/1998 |
| | Emparedados | | | | 12:00 AM |
| | y helados | | | | |
| ANATR | Ana Trujillo | Ana Trujillo | Owner | 10759 | 11/28/1997 |
| | Emparedados | | | | 12:00 AM |
| | y helados | | | | |

In some cases, the reshaping 324 duplicates the related rows from the first table for each related row of the nested table (e.g., OrderID and OrderDate columns). This is reminiscent of a flat join in a relational database, but was performed automatically in response to an expand operation against the navigation column by the embodiment.

As also noted elsewhere herein, some other approaches do not support homogeneous query over expanded navigation properties. Because the data is not reshaped in Open Data protocol when issuing an $expand query, an alternative syntax is used when trying to query against the data in the navigation property (assuming such syntax is even available; sometimes it is not, or the operator is not supported against nested data). For example, filtering the Customers with an Order that has not shipped would require a query like this:

```
  http://services dot odata dot
org/V3/Northwind/Northwind.svc/Customers?$expand=Orders&
      $filter=Orders/any(o: o/ShippedDate eq null)
as opposed to a query to find an order that has not shipped:
    http://services dot odata dot org/V3/Northwind/Northwind.svc/
    Orders?
      $filter=ShippedDate eq null
```

Because some embodiments allow reshaping 324 of the data 118 from expanded navigation columns into a flat tabular model, the regular query syntax (and complete gamut of operators) can continue to be used. For example, to obtain a filter of Customers with an Order that has not shipped, one could submit a query such as:

SelectRows(#“Expanded Orders”, each ([ShippedDate]=null))

and one could submit a query such as the following to find an order that has not shipped:

SelectRows(Orders, each ([ShippedDate]=null))

Notice that the submitted queries 120 are identical except for the name of the input query.

With regard to optimization of interleaved addition/expansion of navigation columns and other operators, note that although some examples herein explicitly specified the addition of the navigation columns via use of the AddJoinColumn operator, in other cases these navigation columns would have been automatically added when retrieving data from a relational database (e.g. via Sql.Database to retrieve data from a SQL server) and AddJoinColumn would not appear in the queries. For instance: let

```
  Customers = ... /* relational table, no nav cols */,
  Orders = ... /* relational table, no nav cols */,
  CustomersWithOrders = AddJoinColumn(Customers, “CustomerID”, ( )
=> Orders, “CustomerID”)
  US_CustomersWithOrders = SelectRows(CustomersWithOrders, each
Region = “US”),
  #“Expanded Orders” =
ExpandTableColumn(US_CustomersWithOrders, “Orders”,
{“OrderID”, ...})
in
  #“Expanded Orders”
```

CustomersWithOrders would create a table with a navigation column 230 for the Orders of each Customer via the AddJoinColumn call. The ExpandTableColumn call would be matched to the AddJoinColumn call and turned into a flat Join call. This would occur even though the SelectRows call was placed in between them. The final query would be equivalent to:

```
let
  Customers = ... /* relational table, no nav cols */,
  Orders = ... /* relational tabe, no nav cols */,
  FlatCustomersWithOrders = Join(Customers, “CustomerID”, Orders,
“OrderID”)
  Flat_US_CustomersWithOrders =
SelectRows(FlatCustomersWithOrders, each Region = “US”),
in
  Flat_US_CustomersWithOrders
```

With regard to generalization over heterogeneous data sources, one may take the example above but make the Customers and Orders tables each come from a different source (e.g., Customers from SQL, Orders from an Open Data Protocol feed) that have no common query engine between them. One can still do a AddJoinColumn between the tables to correlate the data in a hierarchical fashion and use ExpandTableColumn to flatten the hierarchy. The same optimizations to translate the ExpandTableColumn (AddJoinColumn) pair into a flat Join between the heterogeneous data sources will occur (including the lookthrough of other query operators like SelectRows). At that point, any optimizations in the Join algorithm for joining between the data sources will take over. In a syntax variation, the examples above may be written using “Table.” As an operator prefix, e.g., Table.AddJoinColumn, Table.Join, and so on. One of skill will recognize this as an implementation choice rather than a limitation of every embodiment.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Reference herein to an embodiment having some feature X and reference elsewhere herein to an embodiment having some feature Y does not exclude from this disclosure embodiments which have both feature X and feature Y, unless such exclusion is expressly stated herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways without necessarily omitting desired technical effects from the collection of interacting modules viewed as a whole.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computer-readable storage medium configured with data and with instructions that when executed by at least one processor causes the processor(s) to perform a technical process for improving usability of tabular data by discovering and presenting for use a foreign-key-based relationship between tables of data, the process comprising the steps of:
receiving in a computer-readable memory a first table containing first table data which is organized through first schema information into first table rows and first table columns;
receiving in the computer-readable memory a second table containing second table data which is organized through second schema information into second table rows and second table columns, the first table data and the second table data each including overlapping data, namely, data which is present in both tables, the first table data also containing first non-overlapping data which is not present in the second table, the second table data also containing second non-overlapping data which is not present in the first table;
computationally making a table relationship discovery, namely, discovering a foreign-key-based relationship between the two tables through computational processing of the tables and their schema information without using any human analysis of the tables in order to make the table relationship discovery; and
proactively computationally augmenting a view over data in the first table by adding an expandable hierarchical column to the first table, the expandable hierarchical column including second table data that is related to rows of the first table by the discovered foreign-key-based relationship.

2. The computer-readable storage medium of claim 1, wherein usability is enhanced in that the expandable hierarchical column is a schema-level navigation column which facilitates user-controlled direct navigation between the two tables when data of the tables is being viewed by a human user.

3. The computer-readable storage medium of claim 1, wherein navigation between the tables is enhanced in that prior to the augmenting step neither table included a schema-level navigation column.

4. The computer-readable storage medium of claim 1, wherein the fact that the data spans two tables (rather than being entirely located in a single table) is not disclosed to human users in views of the data prior to the discovering step, and wherein the discovering step occurs in response to a query that invokes both tables.

5. The computer-readable storage medium of claim 1, wherein the discovering step occurs in response to a query that invokes both tables, and the augmenting step comprises placing an AddJoinColumn operator in a query expression tree which represents at least a portion of the query.

6. The computer-readable storage medium of claim 1, wherein the discovering step occurs in response to a query that invokes both tables, and the process further comprises rewriting a query expression tree that represents at least a portion of the query.

7. The computer-readable storage medium of claim 1, wherein the process further comprises expanding the expandable hierarchical column, and reshaping data from a table with a hierarchical column into a flat table which has new columns that contain data from the expanded hierarchical column.

8. The computer-readable storage medium of claim 1, wherein the receiving steps receive data from at least one data source, and data from both tables is received from the same data source, and the process further comprises expanding the expandable hierarchical column, and getting a homogeneous query that is made over the expanded hierarchical column.

9. A technical process for improving usability of tabular data by discovering and presenting for use a foreign-key-based relationship between tables of data, the process comprising the steps of:
receiving in a computer-readable memory from a first table source a first table containing first table data which is organized through first schema information into first table rows and first table columns;
receiving in the computer-readable memory from a second table source a second table containing second table data which is organized through second schema information into second table rows and second table columns, the first table data and the second table data each including overlapping data, namely, data which is present in both tables, the first table data also containing first non-overlapping data which is not present in the second table, the second table data also containing second non-overlapping data which is not present in the first table;
in response to a query that invokes both tables, computationally discovering a foreign-key-based relationship between the two tables;
computationally augmenting a view over data in the first table by adding an expandable hierarchical column to the first table, the expandable hierarchical column including second table data that is related to rows of the first table by the discovered foreign-key-based relationship; and
rewriting a query expression tree which represents at least a portion of the query.

10. The process of claim 9, wherein rewriting the query expression tree comprises placing an AddJoinColumn operator in the query expression tree.

11. The process of claim 9, wherein rewriting the query expression tree comprises at least one of the following:
moving a query operator through an AddJoinColumn operator to settle on another AddJoinColumn operator;
moving a query operator through an AddJoinColumn operator to settle on an initial table value;
moving an ExpandListColumn operator through at least one other operator to settle on a corresponding AddJoinColumn operator;
moving an ExpandRecordColumn operator through at least one other operator to settle on a corresponding AddJoinColumn operator;
moving an ExpandListColumn operator through at least one other operator to settle on another Expand operator;
moving an ExpandRecordColumn operator through at least one other operator to settle on another Expand operator;
replacing an EEA-instance by a flat Join operation between two tables, the EEA-instance including an ExpandRecordColumn which has as an input an ExpandListColumn which has an input an AddJoinColumn which has as inputs the two tables.

12. The process of claim 9, wherein the second table has a name, and the process further comprises naming the expandable hierarchical column based at least in part on the name of the second table.

13. The process of claim 9, wherein the process further comprises expanding the expandable hierarchical column and also comprises at least one of the following:
reshaping data from a table with a hierarchical column into a flat table which has new columns that contain data from the expanded hierarchical column;
getting a homogeneous query that is made over the expanded hierarchical column;
performing a join over heterogeneous sources by performing a join over at least part of each of the two tables after the tables have been received from heterogeneous sources.

14. A computer system comprising:
a logical processor;
a memory in operable communication with the logical processor;
a first table and a second table, each table residing in the memory and having respective data which is organized through respective schema information into respective rows and columns of each table; and
a relationship discovery module which includes relationship discovery code which upon execution by the logical processor interacts with the tables by computationally and proactively making a table relationship discovery, namely, proactively discovering a foreign-key-based relationship between the two tables through computational processing of the tables and their schema information.

15. The system of claim 14, further comprising a view augmentation module that includes view augmentation code which upon execution by the logical processor interacts with the tables by proactively computationally augmenting a view over data in at least one of the tables by adding an expandable hierarchical column to that table, the expandable hierarchical column including data of the other table that is related to rows of the expandable hierarchical column's table by the discovered foreign-key-based relationship.

16. The system of claim 15, wherein the view augmentation code includes code for the following operators: AddJoinColumn, ExpandListColumn, ExpandRecordColumn, and ExpandTableColumn.

17. The system of claim 15, wherein the system further comprises code which upon execution by the logical processor expands the expandable hierarchical column.

18. The system of claim 17, wherein the system further comprises code which upon execution by the logical processor reshapes data into a flat table which has new columns that contain data from the expanded hierarchical column.

19. The system of claim 15, wherein the system further comprises code which upon execution by the logical processor rewrites a query expression tree which represents at least a portion of a query which invoked both of the tables.

20. The system of claim 15, wherein the system further comprises at least one of the following residing in the memory:
a homogeneous query made over the expanded hierarchical column;
a query made after one of the tables came from a non-relational data source;
a query made after one of the tables came from a network database;
a join of the tables after the tables came from heterogeneous sources;
a query made after the tables came from different respective data sources and made while no preexisting query engine other than an instance of the system operates or operated on both of those sources.
